(19) United States
(12) Patent Application Publication
(10) Pub. No.: US 2007/0073900 A1
(43) Pub. Date: Mar. 29, 2007

(54) Parsing apparatus and method for shortening download time delay of data broadcasting application

(75) Inventors: Dong-Hwan Park, Daejeon (KR); Tai-Yeon Ku, Busan (KR); Kyeong-Deok Moon, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics and Telecommunications Research Institute

(21) Appl. No.: 11/413,665

(22) Filed: Apr. 28, 2006

(30) Foreign Application Priority Data
Sep. 29, 2005 (KR) 10-2005-0091610
Oct. 17, 2005 (KR) 10-2005-0097614

(51) Int. Cl. G06F 15/16

(52) U.S. Cl. 709/246

(57) ABSTRACT

Provided is a parsing apparatus and method for shortening a download time delay of data broadcasting application. The paring apparatus comprises a first temporary storage unit for temporarily storing a first message including other module information excluding module information that is being parsed at preset, a second temporary storage unit for temporarily storing a second message including other application data excluding application data referred to by module information that is being parsed at present, a monitoring and downloading unit for receiving and transferring the first message to a parser and searching the second message including application data referred to by module information that is received responsive to the transfer from the second temporary storage unit to send the searched second message to the parser, wherein the second message continuously received is stored in the second temporary storage unit, a version manager for checking a version of the first message provided from the monitoring and downloading unit and delivering the first message to the monitoring and downloading unit to be parsed by the parser when the first message is checked to be a new message, and the parser for receiving and parsing the first message from the monitoring and downloading unit and returning module information to the monitoring and downloading unit, and parsing the corresponding second message upon receipt thereof as the return result.

### FIELD OF THE INVENTION

The present invention relates to a parsing apparatus and method for shortening a download time delay of data broadcasting application; and more particularly, to a parsing apparatus and method for shortening a download time delay of data broadcasting application so as to enhance user convenience by allowing data broadcasting application to be more rapidly downloaded. This can be achieved by making data broadcasting application downloaded using a data and object carousel scheme of Digital Storage Media Control and Command (DSMCC) wherein each of a Download Info Indication (DII) message having module information on application and a Download Data Block (DDB) message having actual application data transmitted is received and then stored in a temporary storage space separately, and thereafter, a previously received DDB message is searched when a certain DII message is received and then they are parsed together to create application objects.

### DESCRIPTION OF RELATED ART

A data broadcasting that offers interactive service using digital data allows users to watch existing television broadcasting programs and also to receive combined services of broadcasting, communications and Internet such as Video On Demand (VOD), banking, shopping mall, picture phone, etc.

This data broadcasting provides various kinds of services by carrying various data and applications as well as video and audio in broadcasting stream and then sending them, in which the services are classified into independent type service and interworking type service depending on a type thereof.

In other words, the service that is offered via channel independently operated with respect to broadcasting program being currently broadcasted is called an independent type service. For example, there are headline news of today, weather forecast, stock quotations, traffic information, and electronic commerce. Meanwhile, the service that provides broadcasting program and related data together is called an interworking type service. As some examples, there are outline and introduction of the cast in the case of drama and introduction of players and records of the game in the case of sports relay broadcasting).

For this data broadcasting, a middleware is needed to enable download and execution of applications between the applications and an operating system of data broadcasting receiver. Such data broadcasting middlewares may be divided into Advanced Common Application Platform (ACAP) in ground wave, Multimedia Home Platform (MHP) in satellite, and Open Cable Application Platform (OCAP) in cable, according to broadcasting media. These middlewares are all based on Globally Executable MHP (GEM) and may have extra Application Programming Interface (API) depending on characteristics of each media. A Java-based data broadcasting application that is executable in those middlewares is named as Xlet.

Meanwhile, the applications in the digital data broadcasting are reconstructed in the form of messages such as Download Server Initiate (DSI), DII and DDB based on a data and object carousel scheme of DSMCC; and then multiplexed and periodically transmitted together with video and audio. There will be described later with respect to a type (DSI/DII/DDB) of each message which is defined by DSMCC.

The DSMCC that is MPEG-2 standard part 6 is a public protocol that is proposed to provide multimedia services over a broadband network. Out of the protocol, in the broadcasting application service related protocol, there are a data carousel scheme that periodically sends data module and allows data set to be received by a receiving end, and an object carousel scheme that periodically sends a group of structured objects with directory object, file object and stream object. On the other hand, a DSMCC parser embedded in a data broadcasting receiver completes applications that are reconstructed and transmitted in the form of messages for each module, and then creates each data broadcasting application object through parsing.

One of the prior arts for sending data broadcasting application based on the data and object carousel scheme of DSMCC as mentioned above will be described below with reference to FIG. 1.

FIG. 1 is a flowchart showing an application download method in a data broadcasting receiver according to an embodiment of the prior art.

First, a middleware of the data broadcasting receiver receives new descriptor information through a channel selection or channel change at step S101; and analyzes the descriptor information and judges whether or not application is being broadcasted together at step S102. That is, it judges a presence or absence of application.

In the judgment at step S102, if the application is not being broadcasted, the middleware again performs step S102 that judges the presence or absence of application.

Meanwhile, at step S102, if it is judged that the application is being broadcasted, the middleware receives and analyzes application information at step S103.

In the foregoing process, the application information refers to ID and name of each application and meter data such as various kinds of parameters. A plurality of applications may be broadcasted via a same channel. Next, the middleware provides the analyzed application information via a monitor and receives user's request information thereon. In case of automatically executed application, the middleware goes to a following step, without conducting selection process by the user for application download and execution.

To download the application, the middleware requests DSI information for finding service gateway object information and then receives and analyzes it at step S104.

The service gateway object denotes an object that corresponds to the logically uppermost layer among many objects used in the data broadcasting application. There exists one DSI message every application wherein this should be firstly analyzed in the process of DSMCC parsing. The DSI message is a message containing the information on the service gateway object.

Thereafter, the middleware requests and receives a DII message with module information on a module having the service gateway object by using the service gateway object information acquired through the analysis of the DSI message at step S105.

The DII message refers to a message having information on a specific module downloaded depending on the DSMCC data carousel scheme, that is, a message including module information such as size and version and number of DDB blocks of that module.

Next, the middleware analyzes the received DII message to acquire module information on each module required for application object creation at step S106. And then, it requests and receives related DDB messages with each block of the specific module using the acquired module information at S107.

The DDB message implies a message having actual data organizing each module downloaded based on the DSMCC data carousel scheme, a size of which has a maximum 4,096 bytes.

Subsequently, the middleware collects the DDB messages and organizes and analyzes the corresponding modules at step S108. With this module analysis procedure, it is possible to require additional DII messages; and in this case, the middleware requests, receives and analyzes new DII messages. Based on the analysis result, the collection and module organization and analysis procedures of DDB messages are repeatedly conducted.

Namely, the middleware judges at step S109 whether or not the download of application is completed through the above module analysis procedure. If the judgment result shows that additional DII message is needed, it requests and receives related DII message at step S110; and analyses this and returns to step S106 for acquiring module information of a specific module.

On the other hand, if the judgment result at step S109 shows that extra DII message is not needed or the download of application is completed, at step S111, the middleware monitors version information of DII messages to watch a change of information and data. When any change of information and data of application is sensed, the middleware receives a new version of DII message and returns to step S106 for analyzing this and acquiring module information thereon. If a user input interrupt is occurred, for example, if a channel change is made, of course, the process in the middleware is ended.

In the conventional application downloading process, however, additional DII message may be required during the module analysis. In this case, a new DII message is requested, received and analyzed; and it needs to repeatedly wait a new period of broadcasting carousel in order to request and receive new DDB messages, in response to the analysis result.

In other words, the conventional data broadcasting receiver repeatedly requests and receives DII/DDB messages according to the module analysis procedure, which causes a download time delay due to such a request and reception.

### SUMMARY OF THE INVENTION

It is, therefore, a primary object of the present invention to provide a parsing apparatus and method for shortening a download time delay of data broadcasting application so as to improve user convenience by allowing data broadcasting application to be more rapidly downloaded using a data and object carousel scheme of DSMCC, in which a DII message having module information (e.g., a size and version of a specific module) on application (in case of sports relay broadcasting, application for providing records of the game) being currently broadcasted and a DDB message having actual application data transmitted are received and then stored in a temporary storage space separately, and thereafter, a previously received DDB message is searched when a certain DII message is received and then they are parsed together to create application objects.

In accordance with one aspect of the present invention, there is provided a parsing apparatus for shortening a download time delay of data broadcasting application, the parsing apparatus comprising: a first temporary storage means for temporarily storing a first message including other module information excluding module information that is being parsed at preset; a second temporary storage means for temporarily storing a second message including other application data excluding application data referred to by module information that is being parsed at present; a monitoring and downloading means for receiving and transferring the first message to a parser and searching the second message including application data referred to by module information that is received responsive to the transfer from the second temporary storage means to send the searched second message to the parser, wherein the second message continuously received is stored in the second temporary storage means; a version managing means for checking a version of the first message provided from the monitoring and downloading means and delivering the first message to the monitoring and downloading means to be parsed by the parser when the first message is checked to be a new message; and the parser for receiving and parsing the first message from the monitoring and downloading means and returning module information to the monitoring and downloading means, and parsing the corresponding second message upon receipt thereof as the return result.

In accordance with another aspect of the present invention, there is provided a parsing method for shortening a download time delay of data broadcasting application, the parsing method comprising the steps of: (a) continuously receiving a first message including module information of application and a second message including application data and storing the messages in a first and a second caches, respectively, if the messages are not messages to be parsed at present; (b) parsing a predetermined first message to acquire module information; (c) searching a previously stored second message corresponding to the acquired module information from the second cache; and (d) parsing the searched second message.

The other objectives and advantages of the invention will be understood by the following description and will also be appreciated by the embodiments of the invention more clearly. Further, the objectives and advantages of the invention will readily be seen that they can be realized by the means and its combination specified in the claims.

### BRIEF DESCRIPTION OF THE DRAWINGS

The above and other objects and features of the instant invention will become apparent from the following description of preferred embodiments taken in conjunction with the accompanying drawings, in which:

FIG. 1 is a flowchart showing an application download method in a data broadcasting receiver according to an embodiment of the prior art;

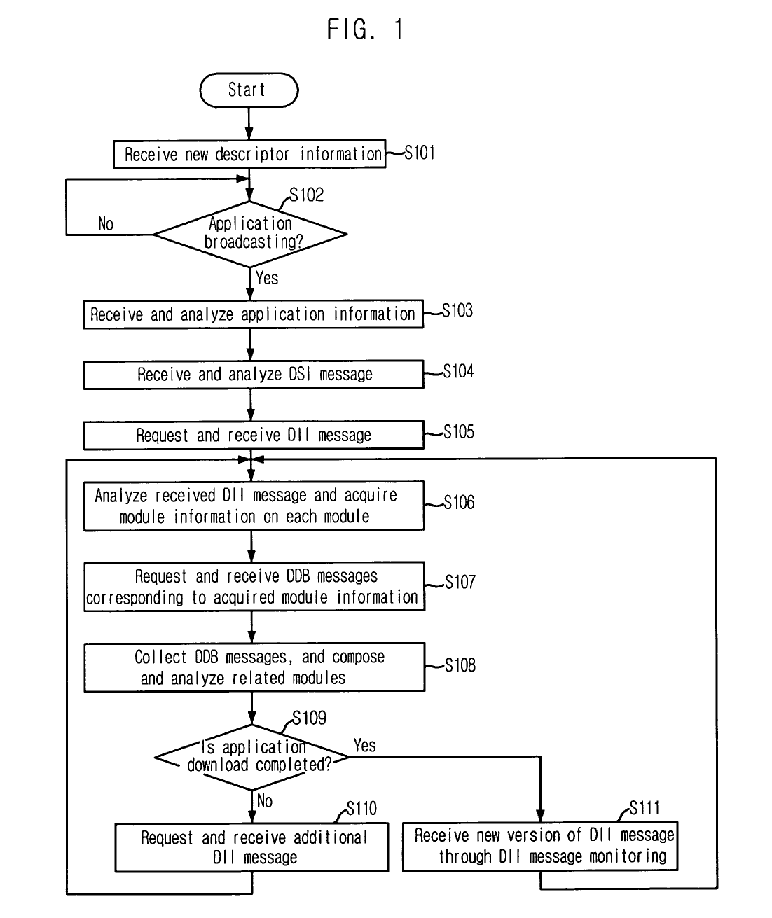

FIG. 2 is a block diagram showing a configuration of a data broadcasting receiver provided with a parsing unit in accordance with an embodiment of the present invention;

FIG. 3 shows a detailed block diagram of the parsing unit for shortening a download time delay of a data broadcasting application in accordance with an embodiment of the invention;

FIG. 4 shows a flowchart for describing a DII monitor thread in the parsing unit in accordance with an embodiment of the present invention;

FIG. 5 illustrates a flowchart for explaining a DDB download thread in the parsing unit in accordance with an embodiment of the invention; and

FIG. 6 is a diagram describing a message caching procedure of shortening the download time delay in the parsing unit in accordance with an embodiment of the invention.

### DETAILED DESCRIPTION OF THE INVENTION

The above-mentioned objectives, features, and advantages will be more apparent by the following detailed description associated with the accompanying drawings; and based on this, the invention will be readily conceived by those skilled in the art to which the invention pertains. Further, in the following description, well-known arts will not be described in detail if it seems that they could obscure the invention in unnecessary detail. Hereinafter, a preferred embodiment of the present invention will be set forth in detail with reference to the accompanying drawings.

The present invention separately transmits module information on application and actual application data using a DSMCC (MPEG-2 standard part 6) data and object carousel scheme, in which a DSMCC parsing unit of data broadcasting receiver downloads in advance data that is expected to be needed later although it is unnecessary at present and stores the same in a temporary storage space; and then uses it when needed for object organization. By doing so, the invention can shorten a download time delay of data broadcasting application.

In the following embodiment, an interworking type data broadcasting service that simultaneously sends application as well as video and audio on data broadcasting will be described as one example.

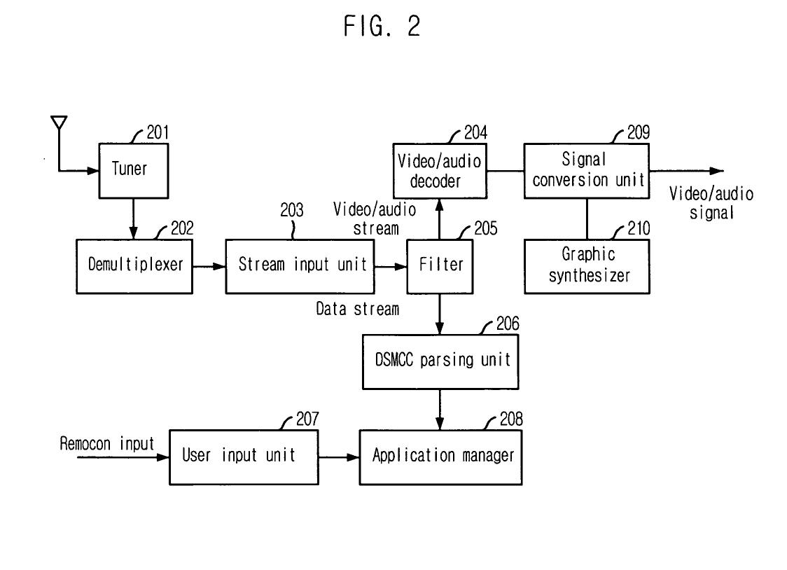

FIG. 2 is a block diagram showing a configuration of a data broadcasting receiver provided with a parsing unit in accordance with an embodiment of the present invention.

As shown therein, the data broadcasting receiver having the parsing unit of the invention comprises a tuner 201 for receiving digital broadcasting signals and selecting a desired channel, a demultiplexer 202 for converting the signal received via the selected channel into an MPEG-2 transmission stream, a stream input unit 203 for selectively taking the input of the stream, a filter 205 for separating a video/audio stream and a data stream from the MPEG-2 transmission stream, and a video/audio decoder 204 for extracting and decoding video/audio information from the video/audio stream. In addition, the inventive data broadcasting receiver further comprises a signal conversion unit 209 for converting the decoded video/audio signal into a signal that is adapted to display on a display device (not shown), a graphic synthesizer 210 for synthesizing an application picture with a video picture to transfer a synthesized picture to the signal conversion unit 209, a DSMCC parsing unit 206 for extracting and parsing program information and application data from the data stream provided from the filter 205, a user input unit 207 for accepting various remote controller signals, and an application manager 208 for taking charge of initialization, execution, deletion, etc. of downloaded application.

Specifically, the DSMCC parsing unit 206 of the invention serves to parse a message of form defined by DSMCC to generate data broadcasting application objects. That is, it analyzes a DII message to find a size, version, and number of DDB blocks of a specific module and receives each block corresponding thereto through DDB message; and then completes each module by operating in such a manner of organizing the module and creates data broadcasting application objects through parsing.

In this process, the DSMCC parsing unit 206 stores DDB message having blocks forming the module, which is reception-completed but not required for organization of current application object, in a temporary storage space, i.e., a DDB cache. And when the DII message referring to the DDB message is received, the caching DDB message is taken and conducted by the parsing procedure.

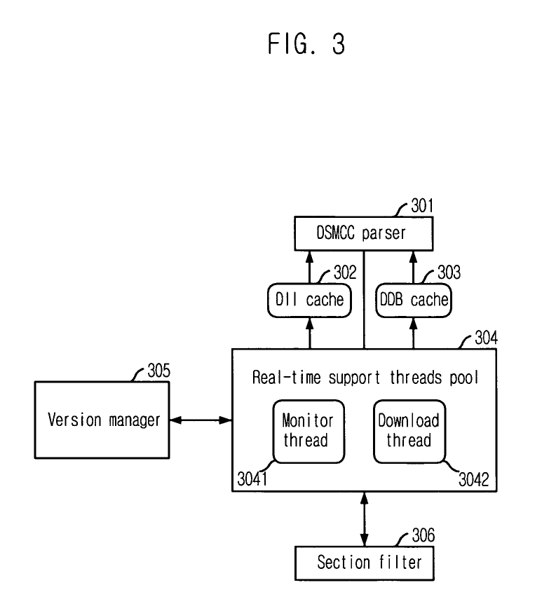

Now, a more detailed description of the configuration and operation of the DSMCC parsing unit 206 will be provided with reference to FIG. 3.

FIG. 3 shows a detailed block diagram of the parsing unit 206 for shortening the download time delay of the data broadcasting application in accordance with an embodiment of the invention.

As shown in FIG. 3, the parsing unit 206 for shortening the download time delay of the data broadcasting application includes a DSMCC parser 301 for parsing each message to create application objects, a DII cache 302 for temporarily storing DII message, a DDB cache 303 for temporarily storing DDB message, a real-time support threads pool 304, and a version manager 305 for monitoring a version of each message to judge whether or not the message is a new one. A section filter 306 excluded in the foregoing configuration is the same as that of FIG. 2.

The real-time support threads pool 304 provides a monitor thread 3041 and a download thread 3042.

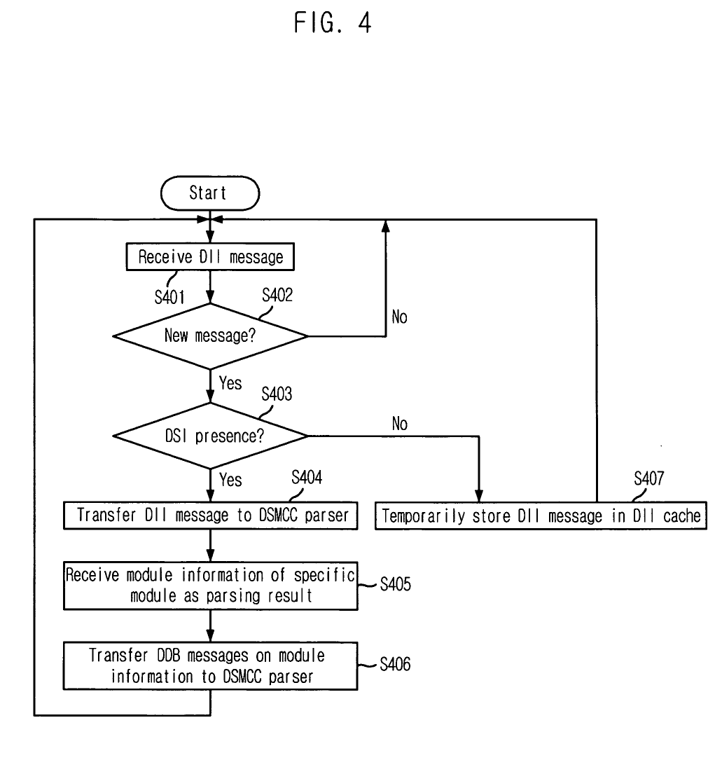

More specifically, the monitor thread 3041 contains a DII monitor thread, an AIT monitor thread and a stream event descriptor monitoring thread, which are provided as threads to monitor various changes related to applications. The DII monitor thread or DII filter thread receives and analyzes DII message; and then delivers it to the DSMCC parser 301 immediately or through its temporary storage. With respect to this, there will be given later referring to FIG. 4. And, the AIT monitor thread is a thread to monitor application information or watch a change of application to be sent within current channel and the stream event descriptor monitoring thread is a thread to watch whether or not a stream event is taken place.

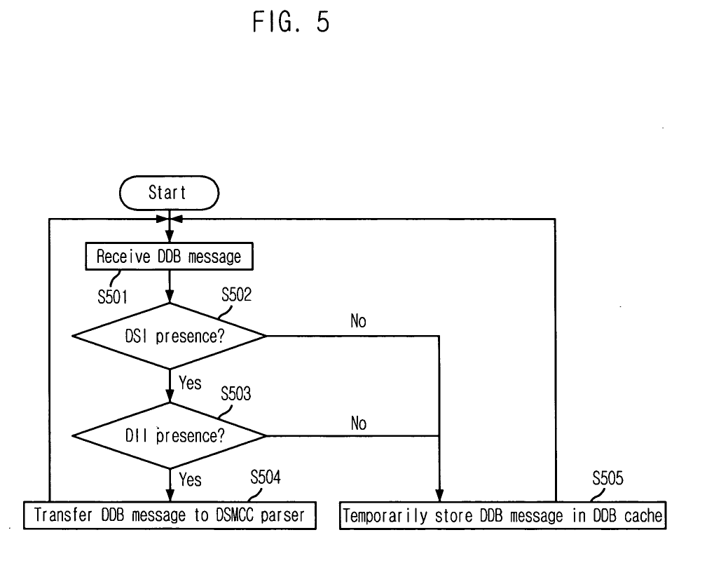

Meanwhile, the download thread 3042 is a thread to receive DDB messages and includes a DDB download thread, a DSI download thread, and a DSMCC module update thread. The DDB download thread or DDB filter thread may be created for each DDB message having a specific DDB block within a specific module or for each specific module wherein details thereof will be discussed later with reference to FIG. 5. The DSI download thread is a thread to receive DSI message and provide service gateway information; and the DSMCC module update thread is a thread to update module when any change is occurred in application.

The real-time support threads pool 304 manages the monitor thread 3041 and the download thread 3042 independently on the basis of the purpose of each filter thread. In the management, if a hardware resource such as filter resource of the section filter 306 is insufficient, i.e., if a confirmation of immediate application update and receipt of stream event object are difficult, it is designed that real-time features are guaranteed by giving the order of priority to each thread and then scheduling the same based on the given order of priority. Namely, the stream event descriptor monitoring thread and the DII monitor thread which are the monitor threads are set to have the relatively high order of priority, thereby monitoring changed matters, e.g., a version of application, related to application at a real-time. Meanwhile, the DSMCC module update thread and the DDB download thread which are the download threads are operated with the relatively low order of priority, thereby securing real-time characteristics.

The various kinds of threads as mentioned above are ended upon receipt of interruption from the user such as channel change and so on.

On the other hand, the version manager 305 manages versions of the DII message and the AIT message provided through the monitor thread 3041. That is, it judges whether or not the received message is a new one and then returns the result to the DII/AIT monitor threads so that the DII monitor thread or AIT monitor thread can decide whether to parse the related message or not. In the foregoing process, if the received message is decided as the AIT message, the operations related to applications broadcasted up to that time are all ended, and thereafter, a new application download process is initiated. Further, the version manager 305 takes charge of the creation of download thread after the initial DDB message is received. For example, if it needs to download new module or new DDB message, a DDB download thread therefor can be produced additionally.

The DII cache 302 temporarily stores DII messages that are not processed by the DSMCC parser 301 at once. For instance, if two DII messages are continuously received, while one DII message is parsed by the DSMCC parser 301, the other DII message is temporarily stored in the DII cache 302.

The DDB cache 303 temporarily stores DDB messages that are not referred to by DII message. In other words, although already received, it temporarily stores DDB messages that are not parsed by the DSMCC parser 301 immediately.

The DSMCC parser 301 parses the messages for each message type defined by DSMCC to thereby create data broadcasting application objects. That is, the DSMCC parser 301 collects DDB blocks from the DDB cache 303 and the stream; and organizes a specific module and analyzes each organized module to lately create data broadcasting application objects. In this process, there may be reference information on new DII message within DII message; and in this case, the DSMCC parser 301 additionally produces a DII monitor thread to receive the new DII message.

FIG. 4 shows a flowchart for describing the DII monitor thread in the parsing unit in accordance with an embodiment of the present invention.

First, the DII monitor thread receives a DII message at step S401; and judges at step S402 whether or not the received DII message is a new one through the version manager 305. That is, it delivers the received DII message to the version manager 305 for its analysis; and receives the analysis result and judges whether the received DII message is a new DII message or a same version of message as a previously received DII message.

If it is judged from step S402 that the received DII message is the same version of message as the previously received DII message, the DII monitor thread omits the parsing process for the DII message. Namely, the DII monitor thread neither delivers the DII message to the DSMCC parser 301 nor stores the same in the DII cache 302. And then, it monitors the receipt of new DII message.

Meanwhile, if it is judged from step S402 that the received DII message is the new DII message, the DII monitor thread judges at step S403 whether or not reference information on the received DII message is acquired through a DSI message by the DSMCC parser 301. The DII message version judgment process is conducted after confirming the presence of a previously received DSI message.

From the judgment at step S403, if the reference information on the DII message is not acquired through the DSI message, the DII monitor thread temporarily stores the received DII message in the DII cache 302 at step S407. That is, the DII monitor thread checks whether or not the DSMCC parser has the reference information on the DII message; and then stores and keeps the DII message in the DII cache 302 until the related reference information is acquired if it doesn't have the reference information.

On the other hand, as the judgment result at step S403, if the reference information on the DII message is acquired through the DSI message, the DII monitor thread delivers it to the DSMCC parser 301 for its parsing at step 404. Then, it takes module information on a specific module as the parsing result. In other words, the DSMCC parser 301 parses the DII message and then returns module information acquired by parsing to the DII monitor thread. The module information returned contains a size, version and number of blocks of the corresponding module.

Next, with the received module information, corresponding DDB messages, i.e., DDB blocks are delivered to the DSMCC parser 301 for their parsing if they are stored in the DDB cache 303 at step S406. That is, the corresponding DDB messages, i.e., DDB blocks are searched from the DDB cache 303 and then fed to the DSMCC 301.

Thereafter, the DII monitor thread returns to step S401 that receives a new DII message.

FIG. 5 illustrates a flowchart for explaining the DDB download thread in the parsing unit in accordance with an embodiment of the invention.

First of all, the DDB download thread receives a DDB message at step S501; and judges at step S502 whether or not there is a previously received DSI message through the DSMCC parser 301.

If it is judged from step S502 that there is no previously received DSI message, the DDB download thread temporarily stores the received DDB message in the DDB cache 303 at step S505.

Meanwhile, if it is judged from step S502 that there is the previously received DSI message, the DDB download thread judges at step S503 whether or not DII message with reference information on the DDB message exists through the DSMCC parser 301. That is, it checks whether or not the DSMCC parser 301 has module information to compose DDB blocks within the DDB message as a specific module.

From the judgment at step S503, if the DSMCC parser 301 doesn't have the reference information, it proceeds to step S505 that temporarily stores the received DDB message in the DDB cache 303.

On the other hand, as the judgment result at step S503, if the DSMCC parser 301 has the reference information, it goes to S504, in which the received DDB message is fed to the DSMCC parser 301 for parsing thereof.

And then, the DDB download thread returns to step S501 that receives a new DDB message.

Each of the DII monitor thread and the DDB download thread described referring to FIGS. 4 and 5 is ended upon receipt of interruption from the user such as channel change. For communications between the treads, well-known techniques may be employed.

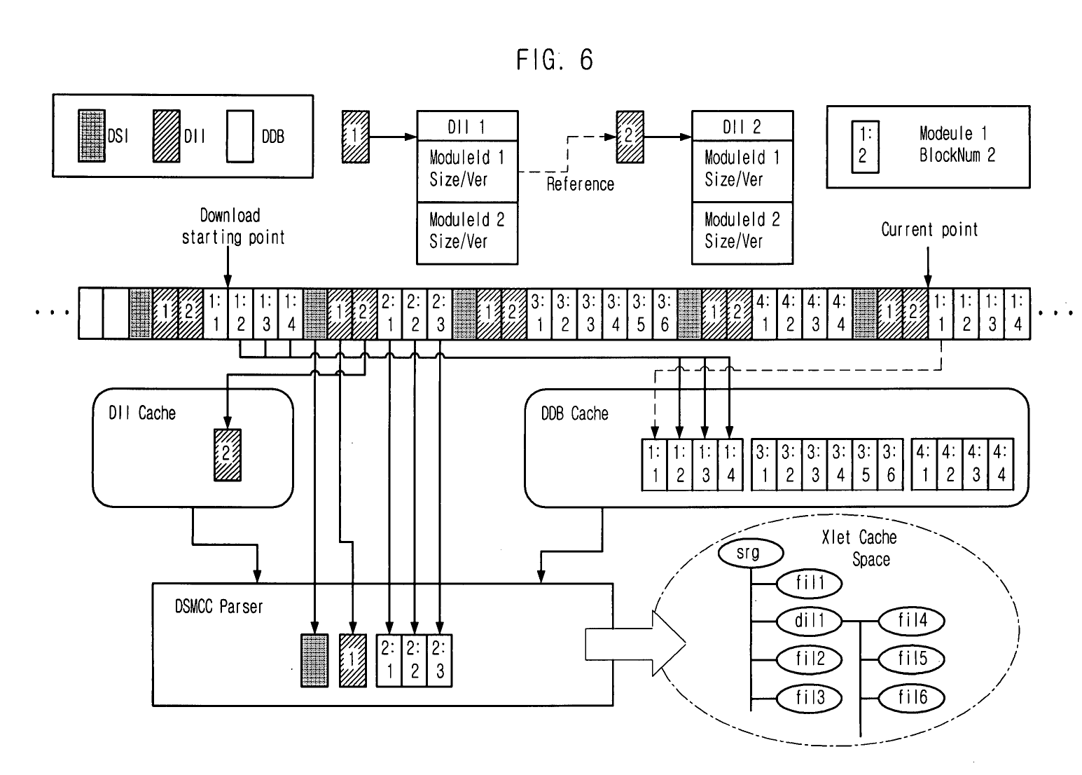

FIG. 6 is a diagram describing a message caching procedure of shortening the download time delay in the parsing unit in accordance with an embodiment of the invention.

The caching of each of the DII message and the DDB message is carried out by the DII monitor thread and the DDB download thread, respectively.

A stream as shown in FIG. 6 includes one DSI message and two DII messages: one DSI and two DIIs, DII 1 and DII2. The DII 1 has module information on a module 1 and a module 2; and the DII 2 has module information on a module 3 and a module 4. Further, reference information on the DII 1 is acquired through analysis of DSI and reference information on the DII 2 is obtained through analysis of DII 1.

At the download starting point, DDB with block 2 data of a module 1 is received. The DDB doesn't include a previously received DSI or DII; and thus, is temporarily stored in the DDB cache 303. Blocks 3 and 4 data of consecutively received module 1 is also stored in the DDB cache 303 for the same reason.

Next, when the DSI is received, it is analyzed by the DSMCC parser 301; and through such process, reference information on DII 1 and information on service gateway object are acquired.

DII 1 received after that is not stored in the DII cache 302 but is delivered directly to the DSMCC parser 301 for parsing thereof since DSI is already analyzed by the DSMCC 301. And module information on modules 1 and 2 is acquired as the parsing result; and according to this, DDB or DDB block constituting modules 1 and 2 is not stored in the DDB cache 303 but is fed directly to the DSMCC parser 301.

On the contrary, DDB forming modules 3 and 4 is temporarily stored in the DDB cache 303 because DII 2 is not analyzed by the DSMCC parser 301.

Therefore, the DDB constituting the modules 3 and 4 is all stored in the DDB cache at the current point, and DDB forming the module 2 is creased with the data broadcasting application object by the DSMCC parser 301. And in the DDB constituting the module 1, the blocks 2 to 4 data excluding the block 1 data is temporarily stored in the DDB cache. After the current point, the block 1 data of module 1 is acquired from the stream, and based on this, the DSMCC parser 301 organizes and analyzes the whole module 1. And reference information on DII 2 is acquired with the analysis result of the module 1 and DDB constituting the modules 3 and 4 is received from the DDB cache 303 thereby organizing the entire application.

As described above, the present invention can shorten a time delay taken for application download. This can be accomplished by downloading module information on application and actual application data separately upon downloading of data broadcasting application in a data broadcasting receiver, in which temporal storage spaces are prepared in a memory; and application data that is expected to be used later is received in advance and stored in the corresponding temporary storage spaces, and thereafter, the stored application data is employed when the corresponding module information is received.

The method of the present invention as mentioned above may be implemented by a software program and stored in a computer-readable storage medium such as CD-ROM, RAM, ROM, floppy disk, hard disk, optical magnetic disk, etc. This process may be readily carried out by those skilled in the art; and therefore, details of thereof are omitted here.

The present application contains subject matter related to Korean patent application No. 2005-0097614, filed with the Korean Intellectual Property Office on Sep. 29, 2005, and Korean patent application No. 2005-0091610, filed with the Korean Intellectual Property Office on Oct. 17, 2005, the entire contents of which are incorporated herein by reference.

While the present invention has been described with respect to the particular embodiments, it will be apparent to those skilled in the art that various changes and modifications may be made without departing from the spirit and scope of the invention as defined in the following claims.

What is claimed is:

1. A parsing apparatus for shortening a download time delay of data broadcasting application, the parsing apparatus comprising:
a first temporary storage means for temporarily storing a first message including other module information excluding module information that is being parsed at preset;
a second temporary storage means for temporarily storing a second message including other application data excluding application data referred to by module information that is being parsed at present;
a monitoring and downloading means for receiving and transferring the first message to a parser and searching the second message including application data referred to by module information that is received responsive to the transfer from the second temporary storage means to send the searched second message to the parser, wherein the second message continuously received is stored in the second temporary storage means;
a version managing means for checking a version of the first message provided from the monitoring and downloading means and delivering the first message to the monitoring and downloading means to be parsed by the parser when the first message is checked to be a new message; and
the parser for receiving and parsing the first message from the monitoring and downloading means and returning module information to the monitoring and downloading means, and parsing the corresponding second message upon receipt thereof as the return result.

2. The parsing apparatus as recited in claim 1, wherein the monitoring and downloading means is implemented by a real-time support threads pool.

3. The parsing apparatus as recited in claim 2, wherein the monitoring and downloading means searches, from the second temporary storage means, the second message including application data referred to by module information that is received as the result after a monitor thread receives and transfers the second message to the parser; and stores the second message continuously received by a download thread in the second temporary storage means.

4. The parsing apparatus as recited in claim 3, wherein the monitoring and downloading means allows kinds of threads contained in the monitor thread to be scheduled with relatively higher priority than that of kinds of threads in the download thread for real-time guarantee.

5. The parsing apparatus as recited in claim 1, wherein the parser receives and parses each of the messages using a Digital Storage Media Control and Command (DSMCC) protocol.

6. The parsing apparatus as recited in claim 5, wherein the module information includes a size, version, number of blocks of each corresponding module.

7. A parsing method for shortening a download time delay of data broadcasting application, the parsing method comprising the steps of:
(a) continuously receiving a first message including module information of application and a second message including application data and storing the messages in a first and a second caches, respectively, if the messages are not messages to be parsed at present;
(b) parsing a predetermined first message to acquire module information;
(c) searching a previously stored second message corresponding to the acquired module information from the second cache; and
(d) parsing the searched second message.

8. The parsing method as recited in claim 7, wherein said step (a) continuously receives the first and the second messages by using a real-time support threads pool.

9. The parsing method as recited in claim 8, wherein said step (a) continuously receives the first and the second messages by using a monitor thread and a download thread, said step (a) allowing kinds of threads contained in the monitor thread to be scheduled with relatively higher priority than that of kinds of threads in the download thread for real-time guarantee.

10. The parsing method as recited in claim 7, wherein said steps (b) and (d) parse each of the messages using a DSMCC parser.

11. The parsing method as recited in claim 10, wherein the module information includes a size, version, number of blocks of each corresponding module.
